(19) United States
(12) Patent Application Publication
(10) Pub. No.: US 2007/0181157 A1
(43) Pub. Date: Aug. 9, 2007

(54) APPARATUS AND METHODS FOR FLUSHING MEDICAL DEVICES

(76) Inventor: Daniel G. Dadourian, Bryn Mawr, PA (US)

Correspondence Address: Vista IP Law Group LLP, 2040 MAIN STREET, 9TH FLOOR, IRVINE, CA, 92614, US

(21) Appl. No.: 11/275,973

(22) Filed: Feb. 7, 2006

(51) Int. Cl. B08B 9/093

(52) U.S. Cl. 134/22.18; 134/22.11; 134/22.15; 134/22.12

(57) ABSTRACT

Apparatus and methods for flushing medical devices are provided. In one embodiment, a flushing apparatus includes a container of carbon dioxide, a filter, a heat exchanger and an actuator for controlling delivery of carbon dioxide from the apparatus. In another embodiment, the flushing apparatus may be a syringe and a reservoir. During use, a medical device may be connected to the flushing apparatus, and carbon dioxide may be delivered from the apparatus into one or more lumens of the medical device to flush the device with carbon dioxide, e.g., to remove trapped air within the medical device. The medical device is then removed from the apparatus and delivered into a patient's body.

### FIELD OF THE INVENTION

The present invention relates generally to apparatus, systems, and methods for flushing medical devices, and, more particularly, to apparatus, systems, and methods for flushing trapped air from catheters or other medical devices using carbon dioxide.

### BACKGROUND

The medical industry performs many procedures using catheters or other medical devices that are inserted into a patient's vasculature. For example, a guide catheter may be introduced into the vasculature and one or more diagnostic and/or procedure catheters or other devices may be delivered via the guide catheter. In addition or alternatively, such devices may be advanced over a guidewire or other rail. Such devices may include one or more lumens that extend between the proximal and distal ends of the devices, e.g., a guidewire or instrument lumen, a perfusion and/or aspiration lumen, and the like. Before such devices are introduced into a patient, they may be prepared by flushing saline through the devices, e.g., into the lumen(s) of the devices.

With such devices, however, there is a risk that air trapped within the devices may enter the patients vasculature, where the air may cause an embolism, potentially leading to heart attack, stroke or visceral organ compromise. As more complex medical devices emerge, such as percutaneous valve replacement systems, the potential for air embolism is expected to rise. Flushing the devices with saline may not adequately displace air from all of the potential spaces within the devices, and therefore there still may be a risk of trapped air escaping from the devices into a patient's vasculature.

Accordingly, apparatus and method for removing trapped air or otherwise reducing the risk of air entering a patient's bloodstream from a device would be useful.

### SUMMARY OF THE INVENTION

The present invention is directed to apparatus, systems, and methods for flushing medical devices, and, more particularly, to apparatus, systems, and methods for flushing trapped air from catheters or other medical devices using carbon dioxide.

In accordance with one embodiment, an apparatus is provided for flushing a medical device that includes a container of carbon dioxide, a filter, a heat exchanger, and an outlet communicating with the container for delivering carbon dioxide from the container to a tubular medical instrument connected to the outlet. The apparatus may include a housing carrying the container, filter, and heat exchanger, and the outlet may communicate with a flow path between the container, filter, and heat exchanger. The apparatus may also include a pressure regulator and/or control valve for controlling flow from the container to the outlet, e.g., to provide a predetermined pressure and/or flow rate for the carbon dioxide delivered from the outlet. In an exemplary embodiment, the pressure may be greater than body pressure, e.g., at least about one or two atmospheres gauge pressure.

Optionally, the outlet may include a connector configured to allow a medical device to be connected to and/or disconnected from the apparatus. In addition or alternatively, the apparatus may include one or more adapters that may be connected to the outlet, e.g., each adapter including a different connector and/or configuration for coupling to a particular medical device.

In accordance with another embodiment, a method is provided for flushing a medical device that includes connecting a proximal end of a tubular medical device to an outlet of a source of carbon dioxide, delivering carbon dioxide from the source to flush a lumen of the medical device, and removing the medical device from the outlet. Thereafter, the medical device may be introduced into a patient's body, e.g., into the patient's vasculature.

In one embodiment, the source of carbon dioxide may be an apparatus including a container of carbon dioxide, a filter, and/or a heat exchanger. Alternatively, the source of carbon dioxide may simply be a syringe filled with carbon dioxide that includes an outlet and/or adapter for delivering carbon dioxide from the syringe into a medical device.

Other aspects and features of the present invention will become apparent from consideration of the following description taken in conjunction with the accompanying drawings.

### BRIEF DESCRIPTION OF THE DRAWINGS

The drawings illustrate exemplary embodiments of the invention, in which:

FIG. 1 is a schematic of an apparatus for flushing medical devices.

FIG. 2 is a side view of an apparatus for flushing medical devices and a catheter being connected to an outlet of the apparatus.

FIG. 3 is a side view of another system for flushing air from a medical device that includes a syringe and a reservoir of carbon dioxide.

### DETAILED DESCRIPTION OF THE PREFERRED EMBODIMENTS

Turning to the drawings, FIG. I shows an exemplary embodiment of an apparatus 10 for flushing medical devices, e.g., with carbon dioxide. The apparatus 10 generally includes a source of carbon dioxide 12, a filter 14, a heat exchanger 16, and a valve 18. The components of the apparatus 10 may be connected together, e.g., using tubing, manifolds, or other structures, to provide a flow path extending from the container 12 through the filter 14, heat exchanger 16, and valve 18 to an outlet 20 of the apparatus 10. Although the components are shown in a particular sequence along the flow path, it will be appreciated that the components may be provided in other sequences and/or configurations. In addition or alternatively, it may be possible to eliminate certain components, e.g., the filter 14, heat exchanger 16, and/or valve 18.

In an exemplary embodiment, the components of the apparatus 10 may be provided within a casing or other housing 22. The outlet 20 may extend from the housing 22 and/or may be a recess or receptacle for receiving a portion of a medical device or an adapter (not shown) therein. The housing 22 may be constructed such that the apparatus is portable. For example, the housing 22 may be provided on a cart (not shown), e.g., including one or more wheels, legs, handles, and the like (also not shown). Alternatively, the housing 22 and/or components may be sufficiently compact and/or light that the apparatus 10 may be easily carried by a user. In this alternative, the housing 22 may include a handle or other feature (not shown) to facilitate handling of the apparatus 10.

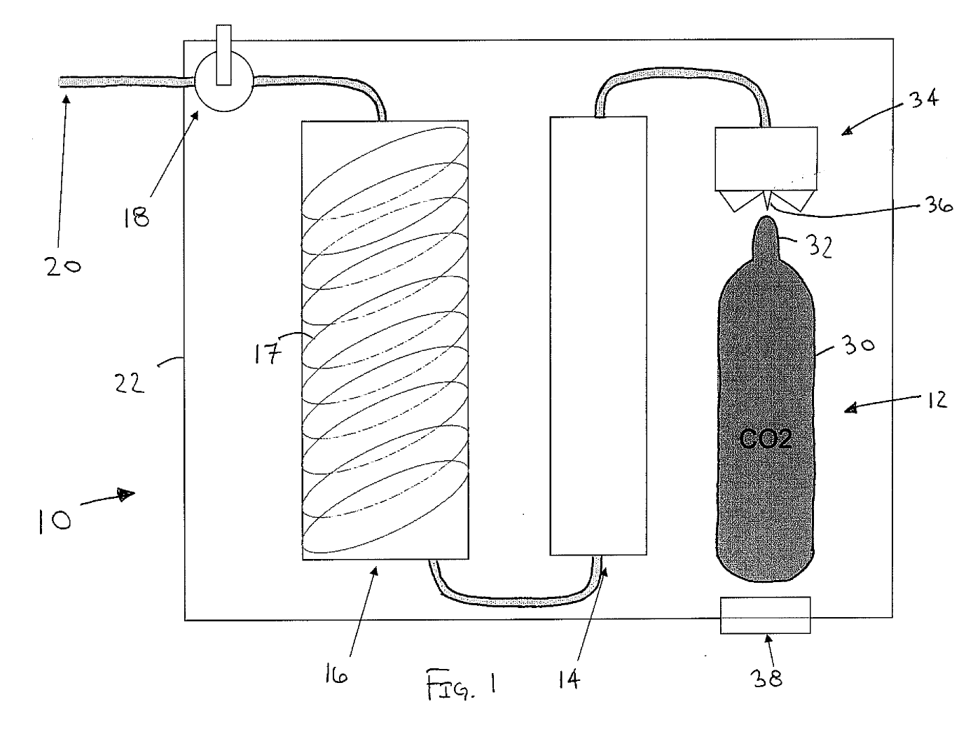

With continued reference to FIG. 1, the source of carbon dioxide 12 generally includes a container holding carbon dioxide 30 and an actuator 34 for selectively delivering carbon dioxide from the container 30 into the flow path. As shown, the container 30 includes an outlet 32, which may include a valve, penetrable plenum, or other structure (not shown) for sealing the outlet 32 yet allowing access to the container 30. The actuator 34 includes a pin 36 disposed adjacent the outlet 32 and a button or other control mechanism 38 for directing the pin 36 into the outlet 32. For example, the pin 36 may include a sharpened tip that penetrates a seal in the outlet 32, thereby allowing carbon dioxide to travel through the pin 36 into the flow path. Alternatively, the pin 36 may simply displace a valve member (not shown) in the outlet 32, thereby allowing carbon dioxide to travel from the container 30 and through the pin 36 into the flow path.

In one embodiment, the container 30 may be movable within the housing 22, e.g., to allow the outlet 32 to be penetrated by the pin 36. For example, the container 30 may be carried by a frame, support, or other structure (not shown) within the housing 22 that may be movable towards and away from the pin 36. The structure may be biased away from the pin 36, e.g., by one or more springs (not shown). The bias may be overcome, for example, by pushing the button 38, thereby moving the structure and container 30 towards the pin 36. Alternatively, the container 30 may be substantially stationary within the housing 22 and the pin 36 may be movable towards and away from the outlet 32.

In one embodiment, the container 30 may be a disposable or reusable tank that may be received in the housing 22. For example, the container 30 may be loaded into the housing 22 and secured to the support structure using one or more straps or other anchors (not shown). The housing 22 may include a hatch or other device for accessing the interior of the housing 22 to allow a container 30 to be removed from and/or loaded into the housing 22. Thus, once the carbon dioxide within a container 30 has been depleted, the container 30 may be removed and a fresh container 30 may be inserted into the housing 22.

Alternatively, the container 30 may be substantially permanently secured within the housing 22. In this embodiment, the entire apparatus 10 may be disposable after the carbon dioxide within the container 30 has been depleted. In a further alternative, the container 30 may be recharged with carbon dioxide and reused. For example, a bypass valve or other device (not shown) may be provided in the flow path, e.g., adjacent the pin 36, that communicates with an adapter or connector. An external source of carbon dioxide may be connected to the adapter, and button 38 actuated to open the flow path from the adapter into the container 30. Carbon dioxide may then be delivered back into the container 30, whereupon, the button 38 may be released and the external source of carbon dioxide may be disconnected.

The button 38 may be attached to housing 22 or other structure within the housing 22, and may manually operated. For example, a user may simply depress the button 38 to cause the container 30 to move into contact with the pin 36. Alternatively, the button 38 may actuate a valve or other mechanism (not shown), e.g., mechanically or electrically, to open the outlet 32 of the container 30.

Still referring to FIG. 1, the filter device 14 may include one or more filter materials for filtering the carbon dioxide from the container 30 before the carbon dioxide is delivered from the outlet 30. For example, the filter 14 may include a macrofilter for removing any particulate from the carbon dioxide flowing through the filter 14. In addition or alternatively, the filter 14 may include a bacterial filter for removing any organisms or other materials to which a patient should not be exposed. The particular material and pore size of the filter 14 are known to those of ordinary skill in the art.

Also as shown FIG. 1, the heat exchanger 16 may include coils 17 for cooling and/or heating the carbon dioxide passing through the heat exchanger 16 along the flow path. For example, if the carbon dioxide is expanded as it exits the container 30, the resulting gas may be substantially cooled. Therefore, it may be appropriate to heat the carbon dioxide to a desired temperature, e.g., to ambient or body temperature, thereby avoiding cooling a medical device being flushed using the apparatus 10. The heat exchanger 16 may include a separate flow path (not shown) for passing the heating or cooling fluid through the heat exchanger 16. For example, the housing 22 may include vents adjacent the heat exchanger 16 such that ambient air may enter the housing 22 and pass along fins or other structures (not shown) on the heat exchanger 16 to warm the carbon dioxide. Alternatively, a refrigerant may be provided in the heat exchanger 16, which may circulate using a pump or other device (not shown).

Optionally, the actuator 34 may include an expander or other structure communicating with the pin 36, e.g., in addition to or instead of the heat exchanger 16. The expander may warm the carbon dioxide escaping the container 30 and/or may reduce the pressure of the carbon dioxide to a predetermined pressure.

With continued reference to FIG. 1, the valve 18 may be a two-position valve, e.g., including an open and closed position. The valve 20 may simply be manually operated, or alternatively, the valve 20 may be a pneumatic or electromechanical valve that may be opened or closed by actuating a switch or other control.

The outlet 20 of the apparatus 10 may include a connector for connecting to a medical device. For example, in one embodiment, the outlet 20 may include a Luer-Lock connector (not shown). Alternatively, the outlet 20 may simply include a nipple around which a medical device may be secured. Optionally, the outlet 20 may include one or more seals to provide a fluid-tight seal when a medical device is connected to the outlet 20, e.g., such carbon dioxide is delivered to the medical device and does not leak substantially.

Optionally, a plurality of adapters (not shown) may be provided that are connectable to the outlet 20. The outlet 20 and one end of each adapter may include mating connectors configured for removably attaching the adapter to the outlet 20. The other end of each adapter may include one or more connectors or other structures allowing a medical device to be connected to the adapter that has a unique configuration Thus, a variety of different medical devices may be connected to and flushed using the apparatus 10. In another option, an elongate flexible tube (not shown) may be connected or otherwise extend from the outlet 20. In addition or alternatively, a nozzle or other transition (not shown) may be provided on the outlet 20 and/or tube. For example, a relatively-narrow and/or elongated needle tip (not shown) may be provided, e.g., which may facilitate flushing small devices, e.g., filter wires, and/or may be inserted into small lumens or orifices of devices.

In another option, the apparatus 10 may include a pressure regulator (not shown), e.g., adjacent the outlet 30 or the pin 36 to control the pressure of the carbon dioxide being delivered by the apparatus 10. For example, the valve 20 may include a pressure monitor regulator and/or orifices or other elements (not shown) for monitoring the pressure adjacent the outlet 20.

Optionally, the apparatus 10 may include a power source or an adapter for connecting to a power source (not shown) for operating electrical components of the apparatus 10. In addition, the apparatus 10 may include one or more circuit boards, displays, or other electrical components. Such components may provide information to a user, e.g., regarding the pressure or flow rate of carbon dioxide being delivered from the apparatus 10 and/or regarding a remaining volume of carbon dioxide within the container 30. In addition or alternatively, such components may control the actuator 34 and/or valve 18.

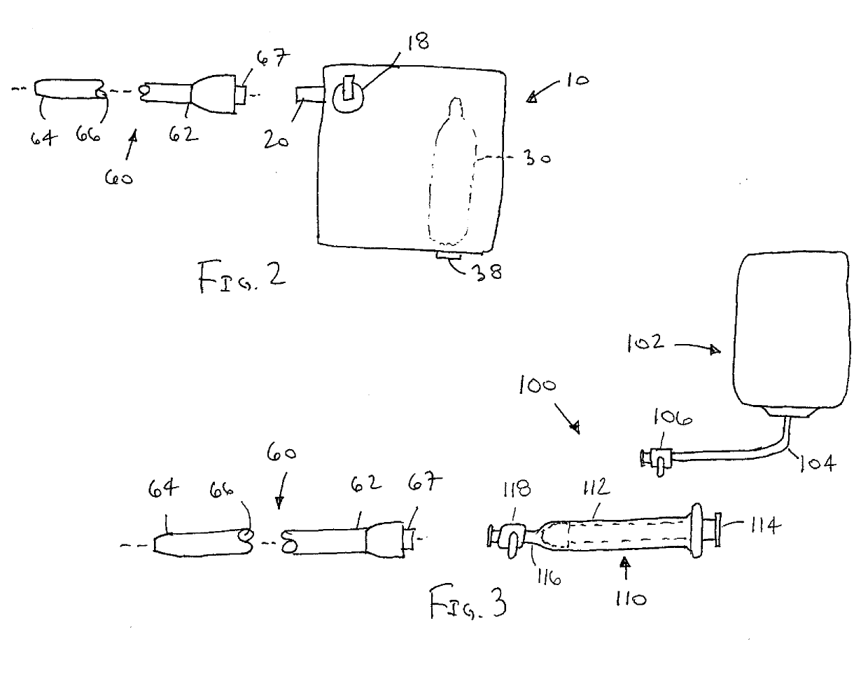

Turning to FIG. 2, a method for flushing air from a medical device 60 using the apparatus 10 will now be described. Initially, a source of carbon dioxide, e.g., the apparatus 10 described above, may be provided. Generally, the medical device 60 includes a proximal end 62, a distal end 64, and at least one lumen 66 extending between the proximal and distal ends 62, 64. The proximal end 62 may include a port 67, which may communicate with the lumen 66. Optionally, the port 67 may include a connector, e.g., a Luer Lock connector and the like (not shown), corresponding to the connector (not shown) on the outlet 20 and/or an adapter (also not shown) connected to the outlet 20. The port 67 of the medical device 60 may be connected to the outlet 20 of the apparatus 10, and carbon dioxide delivered from the outlet 20, through the port 67 and into the lumen 66 of the medical device 60.

For example, before or after connecting the outlet 20 to the proximal end 62 of the medical device 60, the valve 18 may be opened. The button 38 may then be pressed, thereby causing the pin 36 to open the outlet 32 of the container 30. The flow path is then opened, allowing carbon dioxide to pass through the filter 14, heat exchanger 16, valve 18, and outlet 20 into the medical device 60, thereby flushing the lumen 66 with the carbon dioxide. The proximal end 62 of the medical device 60 may then be removed from the outlet 20. Optionally, if the medical device 60 includes additional port(s) and/or lumen(s), the medical device 60 may be connected again to the apparatus 10 to flush the additional lumen(s).

Sufficient volume and pressure of carbon dioxide may be delivered from the apparatus 10 into the medical device 10 to substantially flush trapped air and the like from the lumen 66. For example, the apparatus 10 may deliver carbon dioxide at relatively high pressures, e.g., above body pressure (i.e., about normal pressure encountered within the vasculature or other region of a patient's body), e.g., at least about one or two atmospheres above ambient pressure. The button 38 may be depressed for several seconds or as needed by specific requirements of the particular medical device in order substantially flush the lumen 66.

Once the medical device 60 has been adequately flushed, the apparatus 10 may be removed. If desired, the valve 18 may then be closed. Optionally, the medical device 60 may be further prepared, e.g., flushed with saline and the like. The medical device 60 may then be introduced into a patients body using conventional methods.

Carbon dioxide may be particularly useful for flushing medical devices, because it is highly soluble in blood, e.g., about 54 milliliters of carbon dioxide may be dissolved in one liter of blood (54 mL/L). In contrast, nitrogen (the main component of air) is relatively insoluble in blood. Thus, if an air bubble escapes into a patient's blood stream, the nitrogen may remain out of solution, traveling downstream (potentially to the brain, heart, or other vital organ), where it may become lodged and obstruct blood flow causing severe clinical consequences. Optionally, other highly blood-soluble gases may be provided within the container 30 and apparatus 10 instead of carbon dioxide. For example, inert gases, such as xenon and neon, may be used.

Turning now to FIG. 3, another embodiment of a system 100 is shown for flushing a medical device. As shown, the system 100 includes a reservoir 102 filled with carbon dioxide and a syringe 110. The reservoir 102 may be a bag, tank, or other container filled with carbon dioxide to a predetermined pressure. The reservoir 102 may include a supply line 104 and a valve and/or connector 106.

The syringe 110 includes a barrel 112, a plunger 114 slidable in the barrel 112, and an outlet 116 communicating with an interior of the barrel 112. The outlet 116 may include a valve and/or connector 118. For example, the valve 118 may be connectable to the valve 106 of the reservoir 102 and/or the port 67 of medical device 60. During use, the syringe 110 may be provided initially empty with the valve 118 closed. The valve 106 of the reservoir 102 may be connected to the valve 118. The valves 106, 118 may then be opened, and the plunger 114 withdrawn to draw a desired volume of carbon dioxide from the reservoir 102 into the barrel 112. The valves 106, 118 may then be closed and disconnected.

The valve 118 may then be connected to the proximal end 62 of the medical device 60, whereupon the valve 118 may be opened to deliver carbon dioxide from the barrel 112 through the port 67 and into the lumen 66 to flush the lumen similar to the previous embodiments. Optionally, the plunger 114 may be depressed, e.g., to increase the pressure of the carbon dioxide being delivered into the medical device 60 and enhance the flushing. The valve 118 may then be closed and/or disconnected from the proximal end 62. The medical device 60 may then be delivered into a patient, as described above.

In alternative embodiments, the valve 118 of the syringe 110 may include a connector, e.g., a Luer Lock connector (not shown) for facilitating connection to the reservoir 102 and/or medical device 60. Alternatively, one or more adapters (not shown) may be connected to the valve 118 for providing a desired connector corresponding to a particular medical device being flushed.

In a further alternative, a “T,” “Y,” or other connector (not shown) may be provided instead of the valve 118. The connector may include a three-way valve selectively allowing flow from the outlet 116 of the syringe 110 to a first port (not shown), a second port (also not shown), or closing the outlet 116 from any flow. During use, the reservoir 102 may be connected to the first port and the proximal end 62 of the medical device 60 may be connected to the second port. The valve may be moved to a first position, allowing carbon dioxide to be delivered from the reservoir 102 through the connector into the syringe 102. The valve may then be moved to a second position, allowing the carbon dioxide within the syringe 102 to be delivered through the connector into the medical device 60. The third position may allow the carbon dioxide to be stored temporarily within the syringe 102, e.g., while attaching or removing the medical device 60 and/or the reservoir 102. Such a connector may allow the syringe 102 to be refilled multiple times and deliver multiple volumes of carbon dioxide into the medical device 60 without having to disconnect and/or reconnect the reservoir 102 and/or medical device 60.

It will be appreciated that elements or components shown with any embodiment herein are exemplary for the specific embodiment and may be used on or in combination with other embodiments disclosed herein.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

I claim:

1. An apparatus for flushing a tubular medical instrument to facilitate air removal, the system comprising:
a container holding carbon dioxide;
a filter device communicating with an outlet of the container;
a heat exchanger communicating with the filter device and the container, thereby creating a flow path for carbon dioxide from the container;
an outlet for receiving a proximal end of a tubular medical instrument, the outlet communicating with the flow path; and
an actuator for selectively opening and closing the flow path from the container to the outlet for delivering carbon dioxide from the container into a lumen of the medical instrument communicating with the outlet to flush the lumen with carbon dioxide.

2. The apparatus of claim 1, wherein the actuator comprises a valve.

3. The apparatus of claim 2, wherein the outlet comprises a connector for providing a fluid-tight connection with the proximal end of a medical device.

4. The apparatus of claim 3, wherein the connector comprises at least one of a nipple and a Luer-Lock connector.

5. The apparatus of claim 1, further comprising a pressure regulator communicating with the flow path for regulating pressure of the carbon dioxide delivered from the outlet.

6. The apparatus of claim 5, wherein the pressure regulator is configured for delivering the carbon dioxide from the outlet at a predetermined pressure greater than body pressure.

7. The apparatus of claim 1, further comprising a plurality of adapters connectable to the outlet, each adapter comprising a connector for attaching a medical device having a corresponding configuration to the adapter.

8. A method for flushing a medical device, comprising:
providing a source of carbon dioxide;
connecting a proximal end of the medical device to an outlet of the source of carbon dioxide;
activating the source of carbon dioxide to flush a lumen of the medical device with carbon dioxide; and
removing the medical device from the source of carbon dioxide.

9. The method of claim 8, wherein the medical device is removed from the source of carbon dioxide before the medical device is introduced into a patient's body.

10. The method of claim 9, further comprising introducing a distal end of the medical device into a patient's body.

11. The method of claim 8, wherein the carbon dioxide is delivered at a pressure greater than body pressure.

12. The method of claim 8, wherein the source of carbon dioxide comprises a high pressure container;

13. The method of claim 8, wherein the source of carbon dioxide comprises a syringe, the source being activated by depressing a plunger of the syringe.

14. The method of claim 8, further comprising attaching an adapter to an outlet of the source of carbon dioxide, the adapter comprising a connector corresponding to the proximal end of the medical device.

15. The method of claim 8, wherein the source comprises an apparatus comprising a container of carbon dioxide, and wherein the source of carbon dioxide is activated by activating an actuator on the apparatus.

16. The method of claim 15, wherein the apparatus further comprises a filter, the filter filtering the carbon dioxide from the container before the carbon dioxide flushes the lumen of the medical device.

17. The method of claim 15, wherein the apparatus further comprises a heat exchanger, the heat exchanger warming the carbon dioxide from the container before the carbon dioxide flushes the lumen of the medical device.

18. A method for flushing air from a medical device, comprising:
providing a source of highly blood-soluble gas;
connecting a proximal end of the medical device to an outlet of the source;
delivering the highly blood-soluble gas into the medical device to flush a lumen of the medical device; and
removing the medical device from the outlet.

19. The method of claim 18, wherein the highly blood-soluble gas comprises carbon dioxide.

20. The method of claim 18, further comprising introducing a distal end of the medical device into a patient's body after removing the medical device from the outlet.
